(19) United States
(12) Patent Application Publication
(10) Pub. No.: US 2024/0030859 A1
(43) Pub. Date: Jan. 25, 2024

(54) PLANT FOR THE PRODUCTION OF SOLAR ENERGY THAT CAN BE INSTALLED ON AGRICULTURAL LAND

(71) Applicant: REM TEC S.R.L., Asola (MN) (IT)

(72) Inventors: Alessandro REBOLDI, Rezzato (BS) (IT); Ronald KNOCHE, Garches (FR)

(73) Assignee: REM TEC S.R.L., Asola (MN) (IT)

(21) Appl. No.: 18/256,848

(22) PCT Filed: Dec. 15, 2021
(86) PCT No.: PCT/IB2021/061782

§ 371 Date: Jun. 9, 2023

(30) Foreign Application Priority Data
Dec. 18, 2020 (IT) 102020000031325

(51) Int. Cl. H02S 20/32

(52) U.S. Cl. CPC H02S 20/32

(57) ABSTRACT

Electrical energy production plant comprising a support structure formed by support poles (2) aligned fixed to the ground, to form one (Fi) or more rows (F1 . . . Fn) of poles, a profile or main tube (4) rotating around a first axis (X) positioned on each row (Fi) of poles; a plurality of secondary profiles or tubes (5) rotating around their axis (Y), constrained to said main tubes by means of special bearings (C) and arranged parallel to each other and substantially orthogonal with respect to the axis (X) of these main profiles, a first rotation control mechanism around the axis (X) of the main tubes (4) and a second rotation control mechanism around the axis (Y) of the secondary tubes (5), solar energy receptor devices (P) fixed on these secondary profiles (5) are fixed which orient themselves by rotating around these axes X and Y due to the rotation of these primary and secondary tubes. The second mechanism for controlling the rotation around the axis (Y) of the secondary pipes (5) comprises for each secondary pipe (5) a frame made integral with it, comprising at least two rods or inclined profiles (51), at least one bar (52), and a transmission rod or profile (53) which integrally connects a plurality of bars, determining the formation of groups of secondary tubes in which a substantially horizontal movement of said rod determines the same movement of the frames and secondary tubes (5) belonging to the same group.

The present invention refers to a plant for the production of solar energy formed by a support structure bound to the ground, preferably agricultural ground, suitable for supporting a movement system for devices suitable for receiving sunlight, for example photovoltaic panels. In particular, the movement system of the present invention allows the movement on at least one axis and preferably around two substantially mutually perpendicular axes X and Y of such devices, in order to allow them to keep photovoltaic panels or other devices suitable for capturing solar energy correctly oriented towards the sun.

The support structure allows the ground on which the plant stands to be used for agricultural purposes, i.e. for farming vegetables or for grazing animals.

Systems for moving solar panels on two axes, which are jargonally called “solar trackers”, are known.

The main purpose of a tracker is to maximize the efficiency of the device housed on board. In the photovoltaic field, the modules mounted on board a tracker are generally arranged geometrically on a single panel, thereby avoiding the use of a tracker for every single module. The greater the perpendicular alignment with the sun's rays, the greater the conversion efficiency and the more energy produced for the same surface area, the smaller the surface area of solar panel required for the same output, the lower the plant costs.

The most sophisticated trackers have two degrees of freedom, with which they aim to perfectly align the orthogonal of the photovoltaic panels with the sun's rays in real time. The cheapest, but not the only, way to realize them is to mount one tracker on board another. With these trackers, increases in electricity production of up to 35%-45% can be achieved, but with greater construction complexity.

Such a type of solar tracker is shown in patent application WO2017103953 which describes a bearing structure formed by support poles held in position by a network of tie rods, both the support poles and the tie rods are fixed in the ground by means of pins. The solar tracker comprises a main horizontal bearing profile, which can rotate around its own axis, to which a plurality of secondary profiles are connected, fixed perpendicularly to the main profile and which can be rotated around its own axis. The solar panels are fixed on these secondary profiles. The ends of the main tracker profile are supported and fixed on these support profiles. The electrical cables connecting the various panels and carrying the current generated by them can also be positioned inside the main profile.

Patent WO2013076573 describes a support piling structure of this type that also supports wind modules. This structure is made in a two-dimensional “chequered” fashion and can be installed on agricultural grounds because it is raised and the distance between the support poles is such as to allow the passage of even large agricultural vehicles.

The Applicant has observed that an important aspect for such plants positioned on agricultural ground is the management of the space beneath the support structures of the solar receivers and the configuration of the mechanisms that allow the movement thereof. Indeed, it is important to minimise the size and the area occupied by such mechanisms to maximise the space, for example to allow large agricultural vehicles to pass and at the same time to ensure that the structure and mechanisms are strong, even when it is wished to position bulky and tall receivers.

One aspect of the present invention relates to a solar energy production plant having the characteristics of the appended claim 1.

Further features of the present invention are contained in the dependent claims.

The characteristics and advantages of the present invention will become more apparent from the following description of an embodiment of the invention, provided by way of non-limiting example, with reference to the schematic attached drawings, wherein:

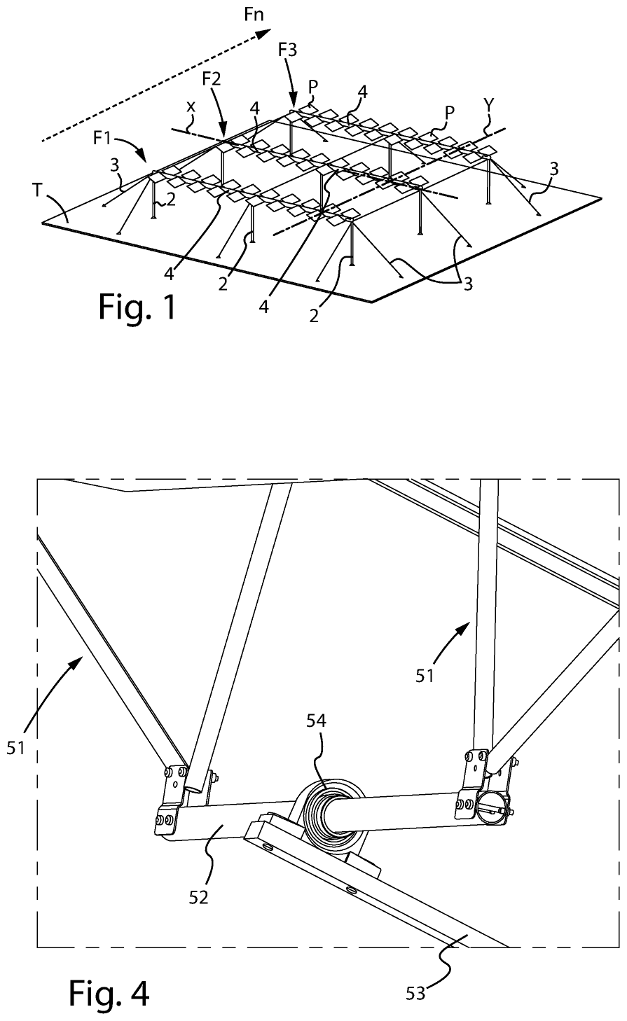

FIG. 1 shows a perspective view of a plant according to the present invention;

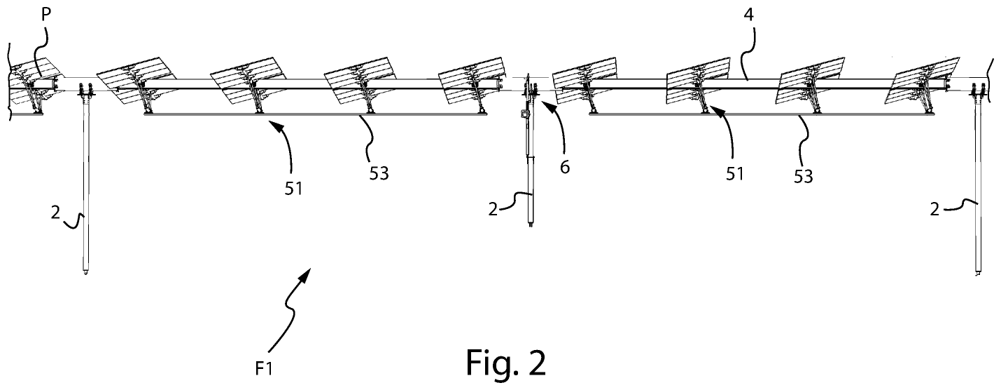

FIG. 2 shows a perspective view of a row of poles of the plant of FIG. 1;

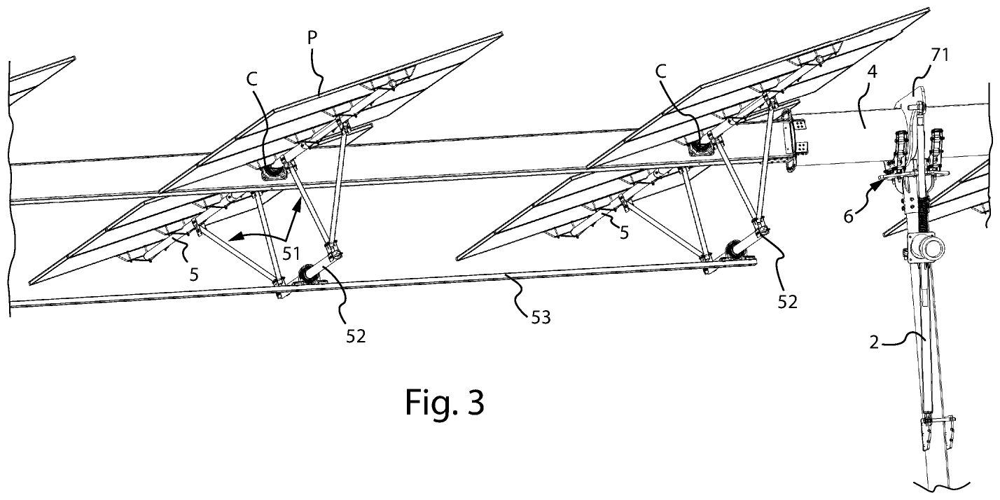

FIG. 3 illustrates a portion of the row of FIG. 2;

FIG. 4 illustrates a detail of the support frame for a photovoltaic panel;

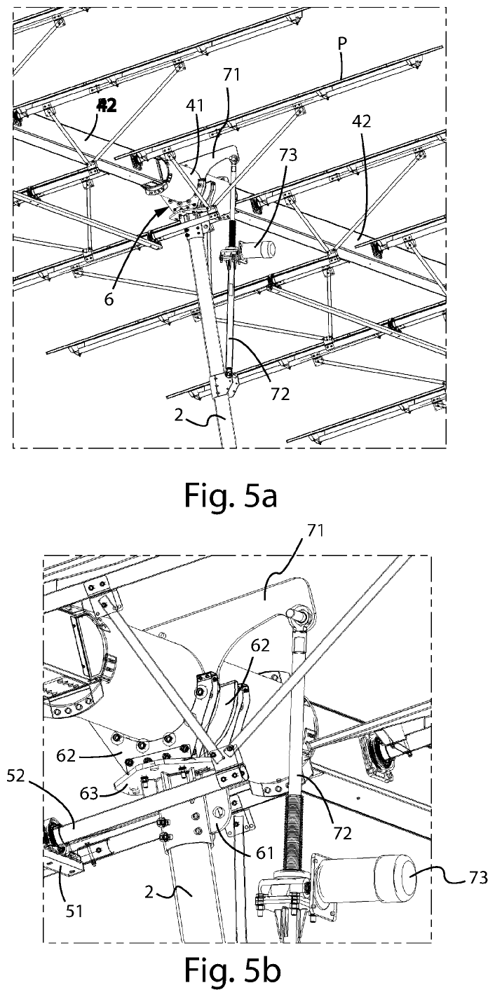

FIGS. 5a and 5b respectively illustrate enlarged details of the joining area between two main tubes at a pole of the plant;

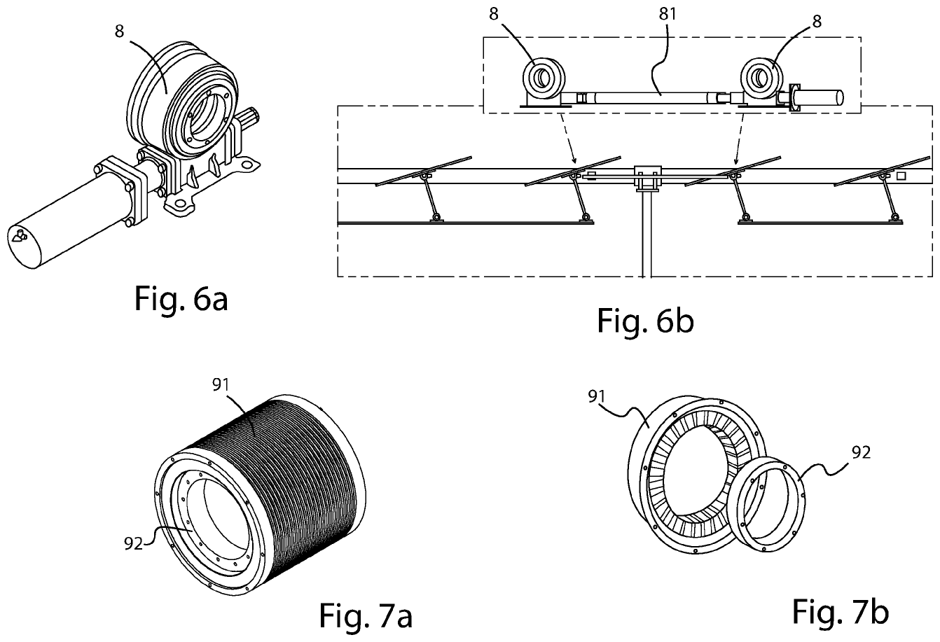

FIGS. 6a and 6b illustrate an actuation system of the “slew drive” type and the joining of two “slew drives” belonging to two adjacent groups of secondary tubes;

FIG. 7 illustrates a movement system of the “rotor-stator” type.

With reference to the quoted figures, the solar energy production plant according to the present invention allows the movement on a first axis X and a second axis Y substantially perpendicular to one another, of devices suitable for receiving sunlight, to allow it to keep a correct orientation towards the sun. For example, such devices are photovoltaic panels or other devices capable of capturing solar energy.

The plant essentially comprises a support structure formed by support poles 2 preferably held in position by a network of tie rods or steel bars 3; both the support poles and the tie rods are fixed to the ground by means of suitable pins, for example hinge pins. The aforementioned poles are organized in a row and there can be from one Fi to many mutually parallel rows F1 . . . Fn in the plant so that the plant itself is in the form of a two-dimensional structure, for example in a “chequered” fashion. The structure can advantageously be installed on agricultural ground, with any orientation, because it is raised and the distance between the support poles is such as to allow the passage of even large agricultural vehicles.

This support structure can alternatively be made by piling in concrete poles, which will have a portion driven into the ground and a part above ground capable of giving the structure adequate height from the ground. Said piling may be or may not be connected by tie rods or steel bars.

A profile, lattice or main tube 4 that rotates about a first axis X is positioned on said support structure and in particular on every row Fi of poles, preferably on top of them. Such a tube can be made by means of a plurality of lengths joined together at or close to intermediate poles of the same row.

A plurality of secondary profiles or tubes 5 rotating around their axis Y by means of special bearings C and arranged parallel to each other and substantially orthogonal with respect to the axis X of the main profiles are constrained on each main tube 4.

The receptor devices, in the specific case illustrated the photovoltaic panels P, which orient themselves by rotating around these axes X and Y due to the rotation of these primary and secondary tubes, are fixed on these secondary profiles. In particular, one or more panels P are fixed on each secondary tube, said panels P being arranged so as to keep the weight of the secondary tube balanced with respect to the primary tube that supports it. For example, if the panels fixed to a secondary tube are a plurality, they are arranged in equal number and/or size on every side with respect to the primary tube that represents the mid-axis (like in the illustrated case) that provides for three panels per side.

The plant comprises a first rotation control mechanism around the axis X of the main tubes 4 and a second rotation control mechanism around the axis Y of the secondary tubes 5.

Such a first mechanism comprises a support and rotation support 6 arranged on each pole of said row, to which the aforementioned tie rods 3 can also be fixed and that has a housing that receives such a main tube 4 and that allows the rotation thereof about such an axis X.

In an alternative embodiment the tie rods can be omitted and the main tube 4 is positioned on a row of poles on top of which the support and movement supports are arranged.

Such a support 6 comprises a lower portion, constrained to the pole, which preferably has four wings 61 orthogonal to each other each adapted for constraining one of the aforementioned tie rods. The upper portion comprises such a housing made from at least one saddle, preferably a pair of saddles 62, resting on a horizontal plate 63 of the support. Such saddles have a substantially circular inner profile adapted for housing the primary tubes, which at least in such an area have a circular profile, and are preferably provided along such a profile with a plurality of bearings 64 that allow the rotation of the tube.

Preferably, according to the present invention, the constraint between two adjacent lengths of main tubes 41 takes place at or close to the pair of saddles, for example by directly joining flanges arranged at the end of the tubes themselves or by joining the two adjacent tubes 41 through opposite flanges by means of a connecting tube or profile 42.

The first rotation control mechanism of the primary tubes also comprises a bracket 71 on at least one pole of said row Fn, said bracket 71 being crimped on the primary tube and integral with it.

Such a bracket is preferably arranged between the two adjacent saddles and is constrained to a linear actuator 72 arranged between the aforementioned bracket and the support pole 2. In this way, by moving the linear actuator, exploiting the support pole as a fixed pin, a rotation movement of the tube 4 is produced. A first electric motor 73 is advantageously used for the movement of the actuator. By actuating such a motor, all of the lengths of primary tubes 4 of a row are set in rotation, since they are constrained to one another by means of the aforementioned flanges.

The second movement mechanism comprises, for each secondary tube 5, a frame made integral with it, comprising at least two rods or inclined profiles 51 and at least one bar 52, beneath the main tube 4 and parallel to said secondary tube.

The second mechanism also comprises a transmission rod or profile 53 which integrally connects a plurality of bars, determining the formation of groups of secondary tubes (and consequently of receptor devices P), in which a substantially horizontal movement of such a rod determines the same movement of the frames and secondary tubes 5 belonging to the same group. For this purpose the connection between the transmission rods and the rotation bars is made through sleeves 54 provided with bearings designed to allow the rotation of the bar with respect to the linear movement of the rod.

Such a support configuration of the secondary tubes, i.e. the presence of a frame arranged beneath the panel, the bars and the transmission rods, determines the formation of a light structure, having better behavior under the loads of the wind, and resistant to the deformations of the secondary tubes under the load of the weight of the panels.

In a first embodiment the second movement mechanism comprises (for every group of secondary tubes) a rotary actuator of the “slew drive” type 8 or equivalent, positioned in place of or integrated with at least one of the bearings C that allow the rotation of the secondary tube with respect to the primary tube to which said actuator is fixed. A secondary tube is then connected to the actuator by means of a flange or other system. The rotation imparted on one secondary tube by the actuator is distributed to all of the other secondary tubes of the same group, exploiting the transmission rod 53, connected by means of the sleeves and the bars to the lattices of the group of secondary tubes. In order to reduce the number of motors of the system, two actuators of two adjacent groups of secondary tubes can be connected by means of the transmission bar 81.

Alternatively, such second movement mechanisms (for every group of secondary tubes) comprise the replacement or integration of at least one of the sleeves 54 with an actuator of the “rotor-stator” type, made up of a stator 91 and a rotor 92 to which a secondary tube will be fixed. Similarly to the previous embodiment, the rotation imparted on a secondary tube by means of such an actuator is distributed by means of the transmission rod to all the other secondary tubes of the same group.

In a further embodiment, such second movement mechanisms (for every group of secondary tubes), comprise the replacement or integration of all of the bearings C with rotary actuators of the “slew drive” type or of the “rotor-stator” type, to which each secondary tube of the same group will be fixed. In such an embodiment the transmission rod 53 and the sleeves 54 can be eliminated.

A further alternative embodiment provides that the second movement mechanism comprises motor means adapted for moving the transmission rods 53, comprising a linear actuator (not shown) for every group of secondary tubes. Said linear actuator is fixed to the main tube 4 and by means of a special sleeve indistinctly actuates a secondary tube or directly the transmission rod. In both cases, by means of the transmission rod the rotation is distributed to all the other secondary tubes of the same group. Clearly, the materials for the various parts have been chosen appropriately for the right balance of weight and strength.

The aforementioned rotation control mechanisms that allow the aforesaid rotations around the axes X and Y are controlled by a special electronic processing unit that determines the angle that the panels must present throughout the day and in all weather conditions, with feedback from a special tilt sensor.

It is possible to comprise in the plant a plurality of devices for monitoring the weather conditions, like for example temperature sensors, humidity sensors, luminosity sensors, solar radiation sensors, atmospheric pressure sensors, sensors for checking the dew point, sensors of the concentration of CO₂, wind measurers regarding speed and direction, rain sensors. Based on the measurements of such sensors, the electronic processing unit determines the positioning moment by moment of the photovoltaic panels.

Electrical energy is obtained from such panels by means of suitable inverters I, which may or may not be connected to the AV electrical mains.

An energy storage system determines the possibility of local storage of such energy necessary. The unit controls in particular the motors that move the solar panels (first X and second Y axis).

1. Plant for the production of electricity comprising
a support structure formed by support poles (2) aligned fixed to the ground, to form one (Fi) or more rows (F1 . . . Fn) of poles,
a profile or main tube (4) rotating around a first axis (X) positioned on each row (Fi) of poles;
a plurality of secondary profiles or tubes (5) rotating around their axis (Y), constrained to said main tubes by means of special bearings (C) and arranged parallel to each other and substantially orthogonal with respect to the axis (X) of these main profiles,
a first rotation control mechanism around the axis (X) of the main pipes (4) and a second rotation control mechanism around the axis (Y) of the secondary pipes (5),
solar energy receptor devices (P) fixed on these secondary profiles (5) are fixed which orient themselves by rotating around these axes due to the rotation of these primary and secondary tubes,
characterized in that the second mechanism for controlling the rotation around the axis (Y) of the secondary pipes (5) comprises for each secondary pipe (5) a frame made integral with it, comprising at least two rods or inclined profiles (51), at least one bar (52), and a transmission rod or profile (53) which integrally connects a plurality of bars, determining the formation of groups of secondary tubes in which a substantially horizontal movement of said rod determines the same movement of the frames and secondary tubes (5) belonging to the same group.

2. Plant according to claim 1, in which the connection between the transmission rods and the bars (52) is made through sleeves (54) provided with bearings designed to allow the rotation of the bar with respect to the linear movement of the rod.

3. Plant according to claim 1, in which the second movement mechanism comprises, in replacement or integration with at least one of the sleeves (54), a motor of the “slew drive” type (8), or equivalent, fixed on the transmission rod (53) so that its rotor is constrained to one of the bars (52).

4. Plant according to claim 1, wherein the second movement mechanism comprises, in replacement or integration with at least one of the bearings (C), a motorized rotary actuator of the “slew drive” type (8), or equivalent, fixed to the main tube (4), so that its rotor is connected to at least one of the secondary tubes (5) belonging to the same group.

5. Plant according to claim 1, wherein the second movement mechanism comprises an actuator of the “rotor-stator” type positioned, in place of or in addition to at least one of the bearings (C), fixed to the main tube (4), so that its rotor is connected to at least one of the secondary tubes (5) belonging to the same group.

6. Plant according to claim 1, wherein the second movement mechanism comprises motorized actuator means adapted to move the transmission rods, acting directly on said rods or on one of the secondary tubes, comprising a linear actuator for each group of secondary tubes.

7. Plant according to claim 1, wherein two adjacent sets of secondary pipes are connected by means of a transmission bar (81).

8. Plant according to claim 1, wherein the second movement mechanism comprises actuator means of the “slew-drive” type or of the “rotor-stator” type in replacement or integration of the bearings (C), with elimination of the transmission bar (53).

9. Plant according to claim 1, in which said rotation control mechanisms which allow the aforementioned rotations around the axes (X) and (Y) are controlled by a suitable electronic processing unit which determines the angle that the panels must present throughout the day and in any climatic condition, with feedback via a special inclination sensor.

10. Plant according to claim 1, wherein said primary tube is made by means of a plurality of lengths joined together at intermediate poles of the same row.

11. Plant according to claim 1, in which the first rotation control mechanism comprises a support and movement support (6) arranged on each pole of said row (Fi), which has a housing which receives said main tube (4) and which allows its rotation around this axis (X); on at least one pole of said row there being a bracket (71) crimped on the primary tube constrained to a linear actuator (72) arranged between the aforementioned bracket and the support pole (2),

12. Plant according to claim 1, characterized in that it is composed of several parallel rows so as to form a “checkerboard” design positioned on an agricultural land, in any orientation.

13. Plant according to claim 1, wherein the receiving devices are photovoltaic panels.
